(19) United States
(12) Patent Application Publication
(10) Pub. No.: US 2006/0272425 A1
(43) Pub. Date: Dec. 7, 2006

(54) Mounting structure of resin molded part

(75) Inventors: Hideto Maeda, Nishikasugai-gun (JP); Daiichiro Kawashima, Nishikasugai-gun (JP); Kazuo Takeda, Nishikasugai-gun (JP)

Correspondence Address: POSZ LAW GROUP, PLC, 12040 SOUTH LAKES DRIVE, SUITE 101, RESTON, VA, 20191, US

(73) Assignee: Toyoda Gosei Co., Ltd., Nishikasugai-gun (JP)

(21) Appl. No.: 11/443,356

(22) Filed: May 31, 2006

(30) Foreign Application Priority Data
Jun. 2, 2005 (JP) 2005-162127

(51) Int. Cl. G01N 3/24

(52) U.S. Cl. 73/842

(57) ABSTRACT

There is provided a resin molded part mounting structure in which a resin molded part is fixed to a mating member via a clip, wherein a connecting portion is provided on the resin molded part, wherein the clip is made up of a seat portion adapted to be joined to the connecting portion and a clip body which has a leg portion which extends from the seat portion and an engaging portion which is formed at a distal end of the leg portion, and wherein a deformable portion which deforms to extend a distance between the resin molded part and the mating member is provided on at least one of the seat portion, the leg portion and the connecting portion.

### BACKGROUND OF THE INVENTION

1. Field of the Invention

The present invention relates to a resin molded part mounting method for fixing a resin molded part to a mating member. A resin molded part mounting structure of the invention can be used as, for example, a mounting structure for fixing a side molding, which is a resin molded part, to a body panel of a motor vehicle, which is a mating member.

2. Related Art

As resin molded parts that are fixed to a mating member via clips, there are known an automotive decorative element such as a side molding 20, a rocker molding 202 and a door molding 203, which are shown in FIG. 11A, and a clouding panel 204, which is shown in FIG. 11B. A side molding, a clip and a body panel, which are common, are shown in FIG. 12 for description of a common resin molded part mounting structure, which will be made as below.

A resin molded part mounting structure shown in FIG. 12 includes a side molding as a resin molded part 110 and a clip 120. A mating member 160 is a body panel of a motor vehicle. The resin molded part 110 is a long material made from a resin, and a connecting portion 111 is formed on a rear surface of the resin molded part 110. A seat portion 121 is formed on the clip 120 in such a manner as to be joined to the connecting portion 111. The connecting portion 111 and the seat portion 121 are joined into an integral unit by such a method as welding, bonding, and fitting. An engaging portion 132 is formed at an end portion of the clip 120 which is opposite to the seat portion 121. An engaged portion is formed on the mating member 160 in such a manner as to be brought into engagement with the engaging portion 132. The engaging portion 132 is formed into a projection, whereas the engaged portion 162 is formed into a hole. The resin molded part 110 is fixed to the mating member 160 through engagement of the engaging portion 132 with the engaged portion 162.

Incidentally, a fixing position of the resin molded part 110 to the mating member is governed by the shape of the mating member 160. Namely, as shown in FIG. 13, when the molding accuracy of the mating member 160 is low, resulting in a recess produced at a portion of the mating member 160 which lies in the vicinity of the engaged portion 162 (hereinafter, the portion being referred to as an engaged region 165), the seat portion 121 of the clip 120 comes closer to the mating member 160 side by such an extent that the engaged region 165 is recessed. Due to this, the resin molded part 110 in which the connecting portion 111 is joined to the seat portion 121 is drawn towards the mating member 160. In the event that only the engaged region 165 is recessed, while the other portion than the engaged region 165 of the mating member 160 (hereinafter, the portion being referred to as a general region 166) is not recessed, the resin molded part is fixed at the general region 166 while being drawn at the engaged region 165 and is then deformed. Due to this, the degree of recess at the engaged region 165 is large, there may occur a case where a front surface 115 of the resin molded part 110 is deformed into a recess. In particular, when the resin molded part 111 is a long material, the deformation of the resin molded part 110 becomes large. When the front surface 115 of the resin molded part 110 is deformed, the appearance of the resin molded part 110 is deteriorated. The degree of recess at the engaged region 165 is too large, the engaging portion 132 cannot reach the engaged portion 162, leading to a case where the resin molded part 110 may not be able to be fixed to the mating member 160.

A resin molded part mounting method has also been proposed in which a distance between a resin molded part and a mating member can be adjusted according to the degree of recess at an engaged region (for example, refer to JP-A-11-20565). According to the resin molded part mounting method disclosed in JP-A-11-20565, a groove is formed along an outer edge of a connecting portion of a resin molded part so that a portion in the vicinity of the connecting portion of the resin molded part is allowed to deflect and deform in a flexible fashion to thereby adjust the distance between the resin molded part and the mating member. However, when the resin molded part is made to deflect and deform, since a front surface of the resin molded part is deformed into a recess shape, the front surface of the resin molded part deforms. Consequently, in also this event, the problem remains unsolved where the appearance of the resin molded part is deteriorated by the deformation of the resin molded part.

There also exists a method in which an elastic portion is formed on a clip in such a manner as to be brought into elastic contact with a resin molded part so as to press the resin molded part in an opposite direction to the elastic portion by means of the pressure of the elastic portion (for example, refer to JP-A-2001-355614). In this case, the deformation of the resin molded part in the vicinity of the elastic portion can be reduced. However, the resin molded part is drawn towards the mating member side by such an extent that an engaged region is recessed while being pressed by the elastic portion. Consequently, the overall deformation of the resin molded part cannot be suppressed, and when the degree of recess at the engaged region is large, a deformation is caused in the resin molded part at a position spaced apart from the elastic portion. Thus, the problem still remains unsolved where the appearance of the resin molded part is deteriorated by the deformation thereof.

### SUMMARY OF THE INVENTION

The invention was made in the light of the situations, and an object thereof is to provide a resin molded part mounting structure which makes it difficult for a front surface of a resin molded part to be deformed when fixed to a mating member.

With a view to solving the problem, according to the invention, there is provided a resin molded part mounting structure in which a resin molded part is fixed to a mating member via a clip, wherein the resin molded part has a connecting portion protruded from a surface thereof, wherein the clip has a seat portion adapted to be joined to the connecting portion and a clip portion which has a leg portion which extends from the seat portion and an engaging portion which is formed at a distal end of the leg portion, and wherein at least one of the seat portion, the leg portion and the connecting portion has a deformable portion which deforms to extend a distance between the resin molded part and the mating member.

The resin molded part mounting structure of the invention preferably includes any of the following configurations (1) to (4) and desirably includes two or more of the configurations (1) to (4).

(1) The seat portion has the deformable portion, which is thin, adjacent to the leg portion.

(2) The seat portion has the deformable portion, which is made from a soft material, adjacent to the leg portion.

(3) The connecting portion has the deformable portion, which is formed into a rib-like shape, provided on the surface of the resin molded part in such a manner as to protrude therefrom.

(4) The seat portion and the clip body may be separately formed.

In the resin molded part mounting structure, at least one of the seat portion, the leg portion and the connecting portion has the deformable portion. In the event that the engaged region of the mating member is recessed largely, the deformable portion deforms to extend the distance between the resin molded part and the mating member. Consequently, even though the engaged region of the mating member is recessed largely, the front surface of the resin molded part deforms in no case. Thus, according to the resin molded part mounting structure of the invention, when fixed to the mating member, the appearance of the resin molded part is deteriorated in no case.

Since no deformable portion is formed on the engaging portion of the clip, even when the deformable portion deforms, the shape of engaging portion is maintained. Consequently, the fixing of the clip to the mating member is never released, and the resin molded part continues to be fixed to the mating member in a stable fashion.

While it may be provided on any of the seat portion, the leg portion and the connecting portion, the deformable portion is preferably provided on the seat portion or the connecting portion. This is because since the seat portion is situated at an end portion of the clip and the connecting portion is situated at an end portion of the resin molded part, the deformable portion can easily be formed on the seat portion and the connecting portion. In the event that the deformable portion is provided on the seat portion, the deformable portion is preferably formed on the seat portion at the boundary portion with the leg portion. This is because a sufficient portion is secured which is joined to the resin molded part so that the resin molded part is fixed to the clip stably. The deformable portion is preferably formed thin or made from a soft material. This is because the deformable portion is made to deform easily.

In the event that the deformable portion is provided on the connecting portion, the connecting portion is preferably formed into a rib shape in such a manner as to project from a surface of the resin molded part. By forming the connecting portion into the rib shape, a function to reinforce the resin molded part can be imparted to the connecting portion. In addition, by forming the connecting portion into the rib shape, a contact area between the other portion than the connecting portion of the resin molded part (hereinafter, the portion being referred to a main body portion) and the connecting portion can be reduced. Consequently, the deformation of the deformable portion is made difficult to be transmitted to the main body portion, whereby the deformable portion can be made to deform while the deformation of the resin molded part is being prevented.

### BRIEF DESCRIPTION OF THE DRAWINGS

FIG. 1 is a cross-sectional view which shows exemplarily how a resin molded part mounting structure of Embodiment 1 is fixed to a mating member which is formed level.

FIG. 2 is a cross-sectional view which shows exemplarily how the resin molded part mounting structure of Embodiment 1 is fixed to a mating member whose engaged region is recessed.

FIG. 3 is a cross-sectional view which shows exemplarily how a resin molded part mounting structure of Embodiment 2 is fixed to a mating member which is formed level.

FIG. 4 is a cross-sectional view which shows exemplarily how the resin molded part mounting structure of Embodiment 2 is fixed to a mating member whose engaged region is recessed.

FIG. 5 is a cross-sectional view which shows exemplarily how a resin molded part mounting structure of Embodiment 3 is fixed to a mating member which is formed level.

FIG. 6 is a cross-sectional view which shows exemplarily how the resin molded part mounting structure of Embodiment 3 is fixed to a mating member whose engaged region is recessed.

FIG. 7 is a cross-sectional view which shows exemplarily how a resin molded part mounting structure of Embodiment 4 is fixed to a mating member which is formed level.

FIG. 8 is a cross-sectional view which shows exemplarily how the resin molded part mounting structure of Embodiment 4 is fixed to a mating member whose engaged region is recessed.

FIG. 9 is a cross-sectional view which shows exemplarily how a resin molded part mounting structure of Embodiment 5 is fixed to a mating member which is formed level.

FIG. 10 is a cross-sectional view which shows exemplarily how the resin molded part mounting structure of Embodiment 5 is fixed to a mating member whose engaged region is recessed.

FIGS. 11A and 11B are explanatory views which show exemplarily a general resin molded part which is fixed to a mating member via clip.

FIG. 12 is a cross-sectional view which shows exemplarily how a conventional resin molded part mounting structure is fixed to a mating member which is formed level.

FIG. 13 is a cross-sectional view which shows exemplarily how the conventional resin molded part mounting structure is fixed to a mating member whose engaged region is recessed.

### DETAILED DESCRIPTION OF THE PREFERRED EMBODIMENTS

Hereinafter, a resin molded part mounting structure of the invention will be described based on the accompanying drawings.

### Embodiments

### Embodiment 1

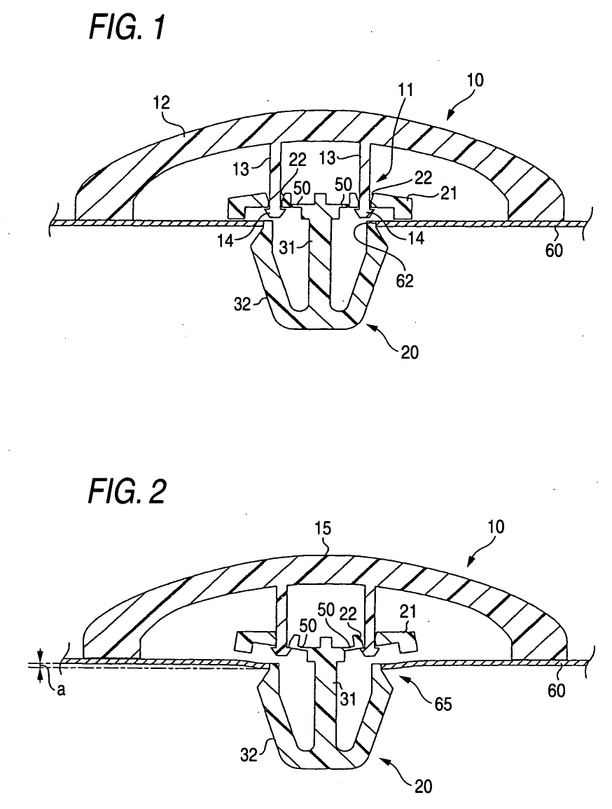

A resin molded part mounting structure according to Embodiment 1 includes a side molding as a resin molded part and a clip. A mating member is a body panel of a motor vehicle. The resin molded part mounting structure of Embodiment 1 includes the configuration (1). Sectional views are shown in FIGS. 1 and 2 which exemplarily show the resin molded part mounting structure of Embodiment 1. FIG. 1 shows how the resin molded part mounting structure is fixed to a mating member which is formed level. FIG. 2 shows how the resin molded part mounting structure is fixed to a mating member which is recessed at an engaged region thereof.

In the resin molded part mounting structure of Embodiment 1, a resin molded part 10 is a long material made from a resin. As shown in FIG. 1, a connecting portion 11 is formed on a rear surface of the resin molded part 10. The resin molded part 10 is made up of the connecting portion 11 and a main body portion 12 which is made up of the remaining portion thereof which excludes the connecting portion 11. The connecting portion 11 is made up of two ribs 13 which extend substantially perpendicularly relative to the main body portion 12. The two ribs 13, which make up the connecting portion 11, are disposed in such a manner as to be spaced apart from each other. Fitting claws 14 like projections are formed at a protruding end of the connecting portion.

A clip 20 is made up of a seat portion 21, a leg portion 31 and an engaging portion 32. The seat portion 21 is formed into a flat plate-like shape. The leg portion 31 is formed into a narrow short strip-like shape and extends substantially perpendicularly from a substantially central portion of the seat portion 21 relative to the seat portion 21. The engaging portion 32 is such as to be substantially folded back from a protruding end portion of the leg portion 31 in such a manner as to extend back to the seat portion 21 side. The engaging portion 32 is formed into an umbrella-like shape which diametrically extends from a connecting portion with the leg portion 31 towards the seat portion 21 side.

Two fitting holes 22 are formed in the seat portion 21 in such a manner as to fit on the fitting claws 14 of the connecting portion 11. The two fitting holes 22 are formed radially further outwards than the connecting portion where the seat portion 21 connects to the leg portion 31 in such a manner as to lie at positions which are symmetrical with each other across the leg portion 31. A boundary portion of the seat portion 21 with the leg portion 31 or a portion of the seat portion 21 which lies closer to the leg portion 31 than the fitting holes 22 is formed thin. This thinned portion makes up a deformable portion 50.

The fitting claws 14 of the connecting portion 11 are formed when fitted in the fitting holes 22 in the clip 20. To describe in detail, the two ribs 13 making up the connecting portion 11 are each formed into a cylindrical shape of a substantially constant cross section which has no projecting claw 14 yet. Therefore, the ribs 13 are allowed to pass through the fitting holes 22 easily. After the ribs 13 are passed through the fitting holes 22, protruding end portions of the ribs 13 which appear from the fitting holes 22 are thermally clamped so as to form fitting claws 14, whereby the connecting portion 11 is fittingly secured in place in the fitting holes 22 in the clip 20 by means of the fitting claws 14 so formed. The connecting portion 11 and the seat portion 21 are joined to each other when the fitting claws 14 ensure that the connecting portion 11 is fittingly secured in place in the fitting holes 22, whereby the resin molded part 10 and the clip 20 are integrated with each other.

An engaged portion 62, which is formed into a hole-like shape, is formed in a mating member 60 at a predetermined position. When mounting the resin molded part mounting structure of Embodiment 1 on the mating member 60, the engaging portion 32 of the clip 20 is passed through the engaged portion 62 of the mating member 60. The engaged portion 62 is formed smaller in diameter than an external shape of the engaging portion 32. The engaging portion 32 once contracts diametrically when passing through the engaged portion 62 and then expands diametrically after having passed through the engaged portion 62, so as to be brought into engagement with the engaged portion 62, whereby the clip 20 is brought into engagement with the mating member 60, and the resin molded part 10 is fixed to the mating member 60 via the clip 20.

As shown in FIG. 2, in the event that an engaged region 65 of the mating member 60 is recessed, a distance between the resin molded part 10 and the mating member 60 is increased. Then, the seat portion 21 of the clip 20 is drawn towards the mating member 60 side by such an extent or a degree a at which the engaged region 65 is recessed. In the resin molded part mounting structure of Embodiment 1, since it is thinned, the deformable portion 50 is made easy to be deformed. The seat portion 21 deflects towards the mating member 60 at around the boundary portion with the leg portion 31 when the deformable portion 50 deforms. Due to this, the distance between the resin molded part 10 and the mating member 60 is increased. In other words, in the resin molded part mounting structure of the embodiment, the degree a of recess of the engaged region 65 can be taken up by the clip 20. Consequently, even though the engaged region 65 of the mating member 60 is recessed largely, there is caused no case where the resin molded part 10 is drawn by the mating member 60, and hence, a front surface 15 of the resin molded part 10 is deformed in no case.

Since no deformable portion is formed on the engaging portion 32 of the clip 20, the shape of the engaging portion 32 is maintained even when the deformable portion 50 deforms. Consequently, the fixing of the clip 20 to the mating member 60 is never released. Thus, the resin molded part 10 and the mating member 60 are fixed to each other in a stable fashion. In addition, the deformable portion 50 of the seat portion 21 is formed at the position which avoids the fitting holes 22. Consequently, the shapes of the fitting holes 22 are maintained even when the deformable portion 50 deforms, and the fitting engagement between the connecting portion 11 and the fitting holes 22 which is ensured by the fitting claws 14 is never released. Thus, the clip 20 and the resin molded part 10 are fixed to each other in the stable fashion.

Note that while, in Embodiment 1, the seat portion 21 and the connecting portion 11 are joined to each other through fitting, the seat portion 21 and the connecting portion 11 may be joined to each other by means of any other methods. For example, they may be joined to each other through such methods as welding, bonding and the like. While, in Embodiment 1, the engaging portion 32 is formed into the umbrella-like shape, the engaging portion 32 may be formed into any other shapes, provided that the engaging portion 32 is allowed to contact and expand diametrically so as to be brought into engagement with the engaged portion 62. While the clip 20 is such that the seat portion 21, the leg portion 31 and the engaging portion 32 are formed integrally with each other, the seat portion 21, the leg portion 31 and the engaging portion 32 may be formed separately for subsequent assembly thereof into an integrated unit.

### Embodiment 2

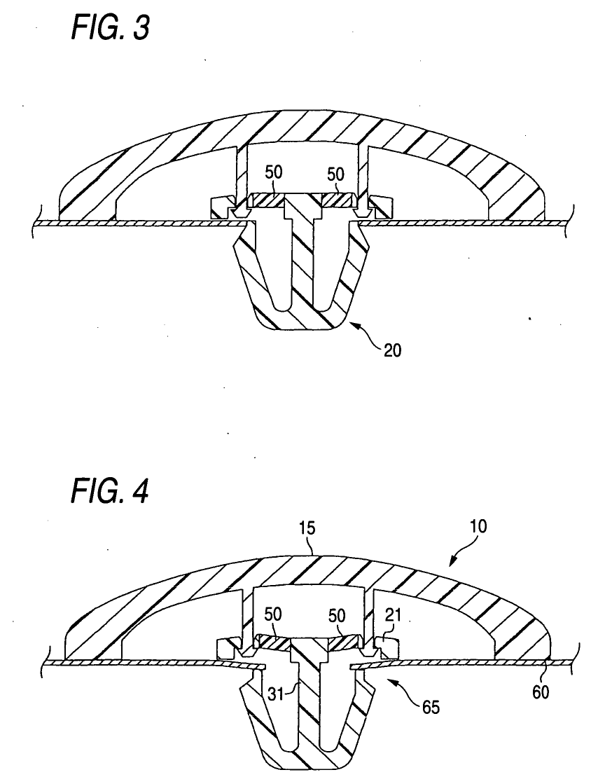

A resin molded part mounting structure according to Embodiment 2 includes the configuration (2). The resin molded part mounting structure of Embodiment 2 is similar to Embodiment 1 except that a deformable portion is made from a soft material. Cross sections are shown in FIGS. 3 and 4 which exemplarily show the resin molded part mounting structure of Embodiment 2. FIG. 3 shows how the resin molded part mounting structure of Embodiment 2 is fixed to a mating member which is formed level. FIG. 4 shows how the resin molded part mounting structure of Embodiment 2 is fixed to a mating member whose engaged region is recessed.

In the resin molded part mounting structure of Embodiment 2, a deformable portion 50 of a clip 20 is made from a soft material such as TPEE (polyester-based elastomer) or rubber added POM (polyoxymethylene). The remaining portion of the clip 20 which excludes the deformable portion 50 is made from PA (polyamide) or POM. The portion of the clip which excludes the deformable portion 50 and the deformable portion 50 are formed into an integrated unit through insert molding.

In the resin molded part mounting structure of Embodiment 2, since it is made from the soft material, the deformable portion 50 is made easy to deform. Consequently, as shown in FIG. 4, in the event that an engaged region 65 of a mating member 60 is recessed, the deformable portion 50 deforms, so that a seat portion 21 is deflected towards the mating member 60 at around a boundary portion with a leg portion 31, so as to extend a distance between a resin molded part 10 and the mating member 60. Consequently, according to the resin molded part mounting structure of Embodiment 2, as with the resin molded part mounting structure of Embodiment 1, even when the engaged region 65 of the mating member 60 is recessed largely, there is caused no case where the resin molded part 10 is drawn by the mating member 60, and hence, a front surface 15 of the resin molded part 10 is deformed in no case.

### Embodiment 3

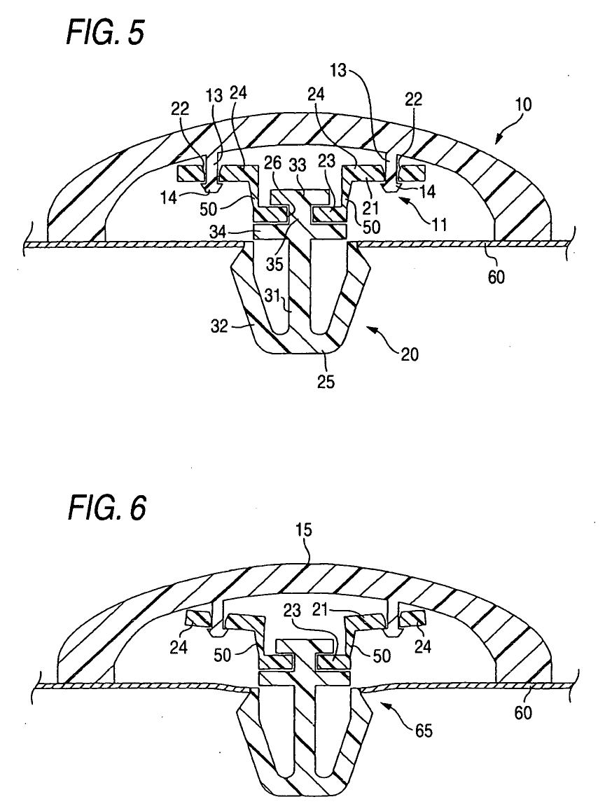

A resin molded part mounting structure of Embodiment 3 is an example where a seat portion of a clip is formed separately from the other portion of the clip for subsequent integration with each other. The resin molded part mounting structure of Embodiment 3 includes the configuration (1). Cross sections are shown in FIGS. 5 and 6 which exemplarily show the resin molded part mounting structure of Embodiment 3. FIG. 5 shows how the resin molded part mounting structure of Embodiment 3 is fixed to a mating member which is formed level. FIG. 6 shows how the resin molded part mounting structure of Embodiment 3 is fixed to a mating member whose engaged region is recessed.

In the resin molded part mounting structure of Embodiment 3, a clip 20 is made up of a clip body 25 which is, in turn, made up of a leg portion 31 and an engaging portion 32 and a seat portion 21, the clip body 25 and the seat portion 21 being formed as separate pieces. The seat portion 21 is formed into a shape in which a substantially central portion is recessed into a groove-like fashion. To describe in detail, the seat portion 21 is made up of a substantially flat plate-like bottom portion 23 and fitting portions 24 which extend from both sides of the bottom portion 23 in a hook-like fashion. A fitting hole 22 is formed in an end portion of the fitting portion 24. A notch-like slide groove 26 is formed in the bottom portion 23. Proximal portions of the fitting portions 24 of the seat portion 21 are formed thin. In the resin molded part mounting structure of Embodiment 3, the proximal portions of the fitting portions 24 make up deformable portions 50.

A first holding portion 33 of a plate-like shape is formed at an opposite end portion of the clip body 25 to the engaging portion 32 in such a manner as to be larger in diameter than the slide groove. In addition, a second holding portion 34 of a plate-like shape is formed at a position which is spaced apart from the slide groove 26 in a direction of a mating member 60 (a direction in which the leg portion 31 extends). The second holding portion 34 is also formed larger in diameter than the slide groove 26. a neck portion 35 of the leg portion 31, which is a portion lying between the first holding portion 33 and the second holding portion 34, is formed slightly smaller in diameter than the slide groove 26. The seat portion 21 and the clip body 25 are integrated with each other due to the neck portion 35 and the slide groove 26 being brought into slide engagement with each other. In addition, the bottom portion 23 is designed to be held by the first holding portion 33 and the second holding portion 34, so that the clip body 25 is prevented from moving in the direction of the mating member 60 relative to the seat portion 21. The engaging portion 32 is formed into the same shape as that of Embodiment 1. A connecting portion 11 made up of two ribs 13 is formed on a resin molded part 10. Fitting claws 14, which are similar to those of Embodiment 1, are formed at an end portion of the connecting portion 11. The seat portion and the resin molded part 10 are joined to each other through the fitting of the connecting portion 11 in the fitting holes 22 which is ensured by the fitting claws 14.

As with Embodiment 1, the resin molded part mounting structure of Embodiment 3 has the thinned deformable portions 50. Due to this, as shown in FIG. 6, in the event that an engaged region 65 of the mating member 60 is recessed largely, the deformable portions 50 deform, and the seat portion 21 deflects in the direction of the mating member 60 at around boundary portions between the bottom portion 23 and the fitting portions 24, whereby a distance between the resin molded part 10 and the mating member 60 is extended. Consequently, even in the event that the engaged region 65 of the mating member 60 is recessed largely, there is caused no case where the resin molded part 10 is drawn by the mating member 60, and hence, a front surface 15 of the resin molded part 10 is deformed in no case.

### Embodiment 4

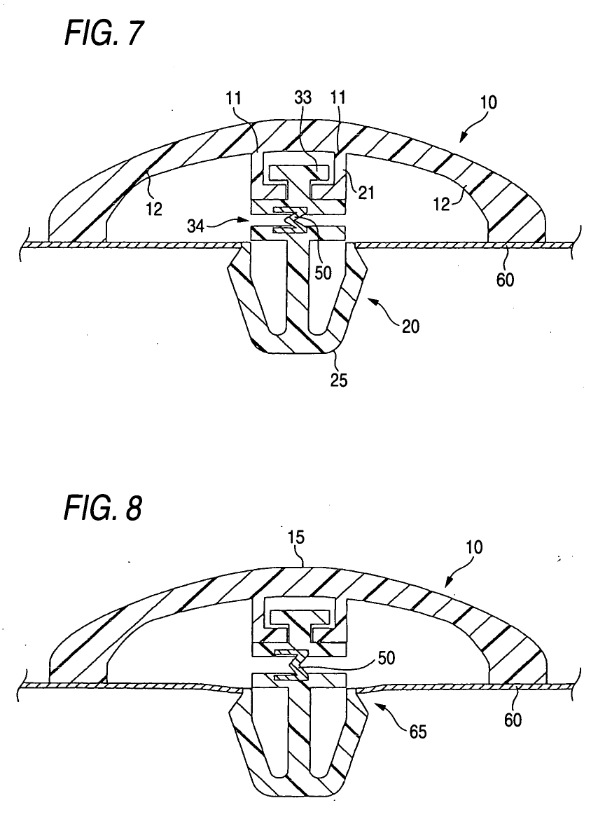

A resin molded part mounting structure of Embodiment 4 is the same as that of Embodiment 3 except that a connecting portion of a resin molded part is formed level with a main body portion thereof, a seat portion and the connecting portion are joined to each other through welding, and a deformable portion is formed on a leg portion. Cross sections are shown in FIGS. 7 and 8 which exemplarily show the resin molded part mounting structure of Embodiment 4. FIG. 7 shows how the resin molded part mounting structure of Embodiment 4 is fixed to a mating member which is formed level. FIG. 8 shows how the resin molded part mounting structure of Embodiment 4 is fixed to a mating member whose engaged region is recessed.

In the resin molded part mounting structure of Embodiment 4, as with Embodiment 3, a clip 20 is such that a seat portion 21 and a clip body 25 are formed as separate pieces. Similarly to Embodiment 3, the seat portion 21 and the clip body 25 are in slide engagement with each other so as to be formed into an integral unit. A connecting portion 11 of a resin molded part 10 is formed level with a main body portion 12 thereof. In addition, the seat portion 21 is formed integrally with the resin molded piece 10 and is joined to the connecting portion 11 which makes up part of the resin molded part 10. As with the clip body 25 of Embodiment 3, the clip body 25 has a first holding portion 33 and a second holding portion 34. In the resin molded part mounting structure of Embodiment 4, the second holding portion 34 is divided into two halves in a thickness direction (a length direction directed towards a mating member 60), and the divided halves are connected by a metallic deformable portion 50. The deformable portion 50 is bent into an S-like shape and is enabled to extend in the direction of the mating member 60.

In the resin molded part mounting structure of Embodiment 4, the deformable portion 50 deforms to extend in the direction of the mating member 60. Consequently, as shown in FIG. 8, in the event that an engaged region 65 of the mating member 60 is recessed largely, the deformable portion 50 deforms to extend a distance between the resin molded part 10 and the mating member 60. Therefore, even in the event that the engaged region 65 of the mating member 60 is recessed largely, there is caused no case where the resin molded part 10 is drawn by the mating member 60, and hence, a front surface 15 of the resin molded part 10 is deformed in no case.

Note that while, in the resin molded part mounting structure of Embodiment 4, the seat portion 21 is formed integrally with the resin molded part 10, the seat portion 21 and the resin molded part 10 may be formed separately, so that the seat portion 21 and the connecting portion 11 are subsequently joined together into an integral unit by means of a method of welding or bonding.

### Embodiment 5

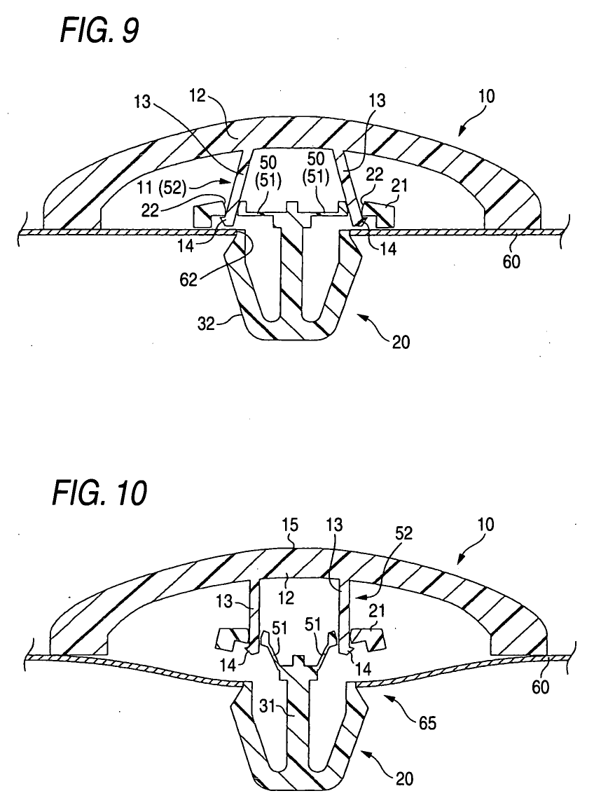

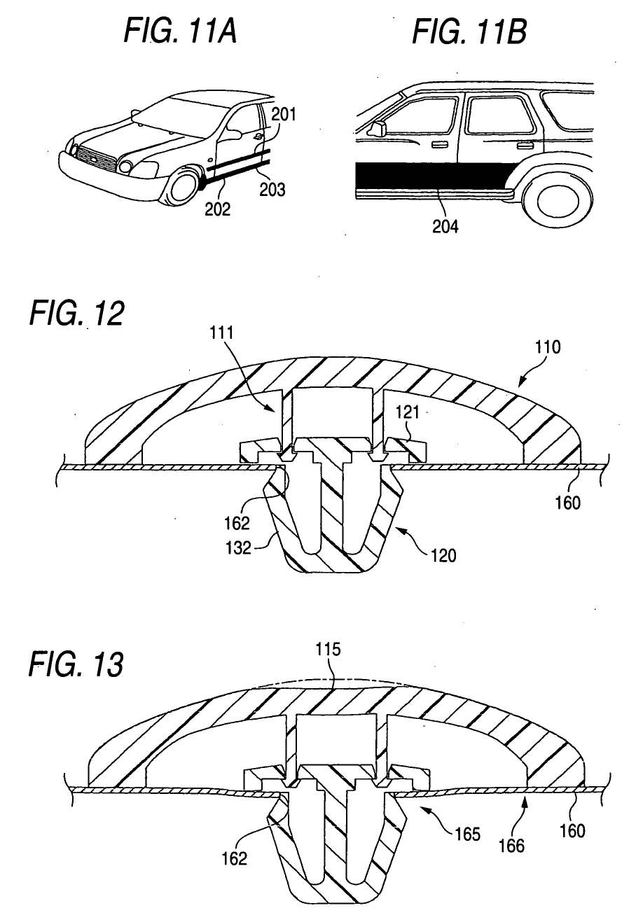

A resin molded part mounting structure according to Embodiment 5 is the same as that of Embodiment 1 except that a deformable portion is also formed at a connecting portion. The resin molded part mounting structure of Embodiment 5 includes the configurations (1) and (3). Cross sections are shown in FIGS. 9 and 10 which exemplarily show the resin molded part mounting structure of Embodiment 5. FIG. 9 shows how the resin molded part mounting structure of Embodiment 5 is fixed to a mating member which is formed level. FIG. 10 shows how the resin molded part mounting structure of Embodiment 5 is fixed to a mating member whose engaged region is recessed.

In the resin molded part mounting structure of Embodiment 5, a clip 20 has the same shape as that of Embodiment 1. Namely, a thinned deformable portion 50 is formed on a seat portion 21 of the clip 20. In the resin molded part mounting structure of Embodiment 5, the deformable portion 50 formed on the seat portion 21 is referred to as a first deformable portion 51.

A connecting portion 11 includes two ribs 13 which are formed on a rear surface of a resin molded part 10. The two ribs 13 making up the connecting portion 11 are disposed in such a manner as to be spaced apart from each other. A distance between the two ribs 13 gradually increases towards protruding end portions thereof, so that the connecting portion 11 expands gradually in diameter towards a protruding end portion thereof. Namely, the two ribs 13 making up the connecting portion 11 extends individually from the rear surface of the resin molded part 10 in an inclined fashion. Fitting claws 14 like projections are formed at the protruding end portion of the connecting portion 11. The connecting portion 11 and the seat portion 21 are joined together when the fitting of the connecting portion 11 in fitting holes 22 in the clip 20 is ensured by the fitting claws 14, whereby the resin molded part 10 and the clip 20 are integrated with each other. The connecting portion 11 (the ribs 13) swings to deform at around boundary portions with a main body portion 12. In the resin molded part mounting structure of Embodiment 5, the entirety of the connecting portion 11 makes up a second deformable portion 52.

When mounting the resin molded part mounting structure of Embodiment 5 is mounted on a mating member 60, an engaging portion 32 of the clip 20 is passed through an engaged portion 62 of the mating member 60. The engaging portion 32 of the clip 20 is brought into engagement with the engaged portion 62 of the mating member 60, whereby the resin molded part 10 is fixed to the mating member 60 via the clip 20.

As shown in FIG. 10, in the event that an engaged region 65 of the mating member 60 is recessed, the first deformable portion 51 deforms. Consequently, the seat portion 21 deflects in a direction of the mating member 60 at around a boundary portion with a leg portion 31. Furthermore, the two ribs 13 swing about the boundary portions with the main body portion 12 in such a manner that the two ribs 13 become in parallel with each other, and the second deformable portion 52 deforms. Then, a distance between the fitting claws 14 and the main body portion 12 is extended, and a distance between the clip 20 and the resin molded part 10 is, in turn, extended. In the resin molded part mounting structure of Embodiment 5, the distance between the resin molded part 10 and the mating member 60 is extended more largely than in the resin molded part mounting structure of Embodiment 1. Consequently, according to the resin molded part mounting structure of Embodiment 5, even in the event that the engaged region 65 of the mating element 60 is recessed more largely compared to Embodiment 1, there is caused no case where the resin molded part 10 is drawn by the mating element 60, and hence, a front surface 15 of the resin molded part 10 is deformed in no case.

What is claimed is:

1. A mounting structure of a resin molded part to a mating member via a clip, comprising:
a resin molded part having a connecting portion protruded from a surface thereof; and
a clip having a seat portion joined to the connecting portion and a clip body which has a leg portion which extends from the seat portion and an engaging portion which is formed continuously from a distal end of the leg portion,
wherein at least one of the seat portion, the leg portion and the connecting portion has a deformable portion which deforms to extend a distance between the resin molded part and the mating member.

2. A mounting structure according to claim 1, wherein the deformable portion is formed thinner than a remaining portion of the seat portion so as to be adjacent to the leg portion.

3. A mounting structure according to claim 1, wherein the deformable portion is made from a soft material so as to be adjacent to the leg portion.

4. A mounting structure according to claim 1, wherein the connecting portion has the deformable portion, which is formed into a rib-like shape, protruded from the surface of the resin molded part.

5. A mounting structure according to claim 1, wherein the seat portion and the clip body is separately formed.

6. A mounting structure of a resin molded part to a mating member via a clip, comprising:
a panel;
a resin molded part mounted on the panel having a connecting portion protruded from a surface thereof; and
a clip having a seat portion joined to the connecting portion and a clip body by which the clip is engaged with the mating member; and
a means for connecting the resin molded part to the clip such that a distance between the resin molded part and the mating member with which the clip is engaged is extendable.

7. A mounting structure according to claim 6, wherein the clip body has a leg portion which extends from the seat portion and an engaging portion which is formed continuously from a distal end of the leg portion, and engaged with the mating member.

8. A mounting structure according to claim 6, wherein a deformable portion formed thinner than a remaining portion of the seat portion is formed in the seat portion.

9. A mounting structure according to claim 6, wherein the seat member is provided with a soft material that is deformable.

10. A mounting structure according to claim 6, wherein the connecting portion has a deformable portion which is formed into a rib-like shape, protruded from the surface of the resin molded part.

11. A mounting structure according to claim 6, wherein the seat portion and the clip body is separately formed.
